(19) United States
(12) Patent Application Publication
(10) Pub. No.: US 2025/0059794 A1
(43) Pub. Date: Feb. 20, 2025

(54) ENCLOSURE

(71) Applicant: Dean GURNEY, Marcoola (AU)

(72) Inventor: Dean GURNEY, Marcoola (AU)

(21) Appl. No.: 18/803,271

(22) Filed: Aug. 13, 2024

(30) Foreign Application Priority Data
Aug. 15, 2023 (AU) 2023902593

(51) Int. Cl. E04H 15/06; B60R 11/00; E04H 15/52; E04H 15/58

(52) U.S. Cl. CPC E04H 15/06; B60R 11/00; E04H 15/52; E04H 15/58; B60R 2011/004

(57) ABSTRACT

A portable enclosure including a collapsible frame adapted to be mounted to a roof rack, roof top tent, or other suitable structure, the collapsible frame being configured for actuation between a storage disposition and an erected disposition, and a flexible wall operatively connected to said collapsible frame, said flexible wall being adapted to be folded or rolled for storage in and/or adjacent said collapsible frame when in the storage disposition and to hang from said collapsible frame when in the erected disposition to form a screen or wall.

### TECHNICAL FIELD

The present disclosure relates to enclosures, with particular application to portable enclosures and more particularly to portable enclosures used for showers, bathrooms, toilets, and change rooms, especially in camping situations. The enclosures of the present disclosure will be described with reference to such application, but may have application to enclosures for other purposes.

### BACKGROUND

Many modern campers typically like to camp in relatively remote places, such as in the Australian outback, on or beside remote beaches and beach reserves, in rainforests, national parks and other places where only four-wheel drive vehicles can gain access. In such places, facilities for cooking, bathing, showering, and toileting are generally not provided. Consequently, such campers generally must take sufficient equipment to facilitate all those necessary activities along with food, water, bedding and many other items which are required even for camping in caravan parks and camping grounds where more facilities are provided. Consequently, limited storage space in camping or towing vehicles is often a difficulty which has to be faced, especially for camping in remote places.

Various portable shower enclosures are available for campers but they are typically small and flimsy, lightweight enclosures which provide little privacy or comfort, although they do not require much storage space in a camping vehicle.

The present disclosure is aimed at providing an enclosure which can provide better privacy and comfort than known lightweight enclosures and which is relatively easy to erect. The disclosure is also aimed at providing an enclosure which does not have to be stored for travel in a vehicle but can be mounted to a roof rack, roof top tent structure or similar suitable structure and stowed for travel while still mounted in such manner.

### SUMMARY

The present disclosure provides portable enclosures for use outdoors or when camping, where the portable enclosures include a collapsible frame and a flexible wall that depends from the collapsible frame.

In an example, the disclosure provides portable enclosures that include a collapsible frame that is adapted to be mounted to a structure, and a flexible wall that is operatively connected to the collapsible frame so that the flexible wall can depend therefrom to form a screen. The collapsible frame includes a door head member and a door support member, the door support member being adapted to move from a closed position adjacent to the door head member to an open position extending from the door head member and vice versa. The flexible wall includes a portion or component that is operatively connected to the door support member so as to hang therefrom to form a door screen.

In another example, the disclosure provides collapsible frames for portable enclosures, where the collapsible frames are adapted to be mounted to a roof structure of a vehicle and include a door head member, and a door support member, where the door support member is adapted to move from a closed position adjacent to the door head member to an open position beyond the door head member and vice versa, the collapsible frame including an attachment mechanism for attaching a hanging flexible wall thereto so that the hanging flexible wall forms an enclosure.

In another example, the disclosure provides portable enclosures that include a collapsible frame adapted to be mounted to a vehicle roof rack, a vehicle roof top tent, or other suitable structure. The collapsible frame is configured for actuation between a storage disposition and an erected disposition, and a flexible wall operatively connected to the collapsible frame, the flexible wall being adapted to be folded and/or rolled for storage in or adjacent the collapsible frame when in the storage disposition and to hang from the collapsible frame when in the erected disposition to form a screen or wall.

In another example, the disclosure provides portable enclosures that include a collapsible frame, and a flexible wall that is operatively connected to the collapsible frame. The collapsible frame is adapted to be mounted to a vehicle roof rack, a vehicle roof top tent, or other suitable structure, whereby the flexible wall can depend therefrom to form a screen. The collapsible frame also includes a door head member and a door support member, where the door support member is adapted to move from a closed position adjacent to the door head member to an open position beyond the door head member and vice versa.

The disclosed features, functions, and advantages of the portable enclosures described herein may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a pictorial representation of an exemplary portable shower enclosure according to the present disclosure mounted to the base of a roof top tent (only the base of the tent being shown) on a 4WD vehicle, with the enclosure shown in its collapsed or storage disposition.

FIG. 2 is a pictorial representation of the portable shower enclosure of FIG. 1 mounted to the base of the roof top tent on the vehicle of FIG. 1 in its erected disposition, as seen from one side.

FIG. 3 is a pictorial representation of the portable shower enclosure of FIG. 1 as shown in FIG. 2 in its erected disposition, as seen from the other side.

FIG. 4 is a pictorial representation of the portable shower enclosure of FIG. 1 mounted to the base of a roof top tent on a 4WD vehicle, with the enclosure shown in its collapsed or storage disposition with the walls removed for clarity.

FIGS. 5A and 5B are pictorial representations of the collapsible frame component of the portable shower enclosure of FIG. 1. FIG. 5A shows the collapsible frame component in its collapsed or stowed disposition with the walls removed. FIG. 5B shows the collapsible frame component in its collapsed or stowed disposition with the walls attached.

FIGS. 6A and 6B are pictorial representations of the collapsible frame component of the portable shower enclosure of FIG. 1. FIG. 6A shows the collapsible frame component of FIG. 5 in its erected disposition with the door support member in its closed position and the walls removed. FIG. 6B shows the collapsible frame component of FIG. 6A in its erected disposition with the door support member in its closed position and the walls attached.

FIGS. 7A and 7B are pictorial representations of the collapsible frame component of FIG. 5A. FIG. 7A shows the collapsible frame component in its erected disposition with the door support member in its open position and the walls removed. FIG. 7B shows the collapsible frame component in its erected disposition with the door support member in its open position and the walls attached.

FIG. 8 is a top plan view of the collapsible frame component of FIG. 5 in its erected disposition with the door support member in its closed position.

FIG. 9 is a sectional elevation of the collapsible frame component of FIG. 5 along line 9-9 in its erected disposition with the door support member in its closed position.

FIG. 10 is an enlarged view of one hinge portion of the collapsible frame component of FIG. 5 at Detail 10.

FIG. 11 is an enlarged view of the connection between the frame members and the door latch mechanism of the collapsible frame component of FIG. 5 at 11 in FIG. 9.

FIG. 12 is an enlarged view of the connection between the frame members and the door latch mechanism of the collapsible frame component of FIG. 5 at 12 in FIG. 8.

FIG. 13 is a sectional elevation of part of the collapsible frame component of FIG. 5 along line 13-13 in FIG. 8 in its erected disposition with the door support member in its closed position.

FIG. 14 is a pictorial representation of the collapsible frame component of FIG. 5 in its partly erected disposition with the door support member in its almost closed position.

FIG. 15 is an enlarged view of the connection between the frame members and the door latch mechanism of the collapsible frame component of FIG. 5 at 15 in FIG. 14.

FIG. 16 is a pictorial representation of the collapsible frame component of FIG. 5 in its erected disposition with the door support member in its almost closed position.

FIG. 17 is an enlarged view of the connection between the frame members and the door latch mechanism of the collapsible frame component of FIG. 5 at 17 in FIG. 16.

FIG. 18 is a pictorial representation of the collapsible frame component of FIG. 5 in its erected disposition with the door support member in its fully closed position.

FIG. 19 is an enlarged view of the connection between the frame members and the door latch mechanism of the collapsible frame component of FIG. 5 at 19 in FIG. 18.

### DETAILED DESCRIPTION

With the foregoing in view, the present disclosure is broadly directed to a portable enclosure including:
a collapsible frame adapted to be mounted to a roof rack, roof top tent, or other suitable structure, the collapsible frame being configured for actuation between a storage disposition and an erected disposition, and a flexible wall operatively connected to said collapsible frame, said flexible wall being adapted to be folded or rolled for storage in and/or adjacent said collapsible frame when in the storage disposition and to hang from said collapsible frame when in the erected disposition to form a screen or wall.

In another aspect, the present disclosure is broadly directed to a portable enclosure including:
a collapsible frame and a flexible wall operatively connected to said collapsible frame, said collapsible frame being adapted to be mounted to a roof rack, roof top tent or other suitable structure, whereby said flexible wall may depend therefrom to form a screen, said collapsible frame including a door head member and a door support member, said door support member being adapted to move from a closed position adjacent said door head member to an open position extending substantially beyond said door head member and vice versa.

In yet another aspect, the present disclosure is broadly directed to a portable enclosure including:
a collapsible frame and a flexible wall operatively connected to said collapsible frame, said collapsible frame being adapted to be mounted to a roof rack, roof top tent or other suitable structure whereby said flexible wall may depend therefrom to form a screen, said collapsible frame including a door head member and a door support member, said door support member being adapted to move from a closed position adjacent said door head member to an open position substantially beyond said door head member and vice versa and said flexible wall including a portion or component operatively connected to said door support member so as to hang therefrom to form a door.

In still yet another form, the present disclosure is broadly directed to a collapsible frame for a portable enclosure, the collapsible frame being adapted to be mounted to a roof rack, roof top tent or other suitable structure and including a door head member and a door support member, said door support member being adapted to move from a closed position adjacent said door head member to an open position substantially beyond said door head member and vice versa and the frame including attachment means for attaching a flexible wall thereto so as to hang therefrom to form an enclosure.

Preferably, said collapsible frame includes a base member which is adapted to be mounted to the roof rack, roof top tent or other structure by bolts, screws or other suitable fasteners and the other frame members are operatively connected to the base member and arranged to fold towards the base member one after the other so that the first one is against the base member and the second is against the first and so on.

In such form of the enclosure, it is preferred that there be two opposed side members and the door head member. In such form of the enclosure, it is preferred that the door support member be arranged to fold against the door head member and more preferably fold about the door head member.

In a particularly preferred form, the door support member is selected to partially encapsulate the door head member thereby minimizing space when the collapsible frame is in the fully collapsed disposition and such that the door support member is fully supported by the door head member when in the closed position. In that respect, it is preferred that the collapsed frame does not extend sideways from the roof rack, roof top tent or other structure beyond the vehicle or cause undesirably large wind resistance. In one embodiment, the door support member is an extruded aluminum tube of rectangular cross-section and the door head member is an extruded aluminum channel member which is selected to abut three sides of the rectangular tube.

It will be appreciated that while the enclosure can be mounted to a roof rack, roof top tent or other part of the vehicle or other structure attached to the vehicle, the enclosure when in its storage disposition may also be packed in the vehicle and then erected at a selected campsite by securing it to a tree, post, rock, fence, pole or any other suitable structure or thing. In that respect, it will be appreciated that the base member may be provided with a plurality of openings or other suitable means for accepting screws or bolts or wire to assist with securing it to another suitable structure or thing.

It is also preferred that the door support member and the door head member have complementary latching means whereby the door screen or door component may be opened and closed and latched in the closed position when desired.

Preferably, the base member includes a hook or an opening for supporting a shower rose, or shower head, thereon. In such form it is preferred that the rear wall or wall portion hanging from the base member is arranged to extend fully to the ground whereby water is prevented from impinging on the vehicle or any other structure to which the enclosure is mounted. In one such form, the rear wall also includes a window portion which can be opened and closed to access clothes beside the rear side of the enclosure. In one such form, the window is arranged to align generally with a vehicle window that may be located beside a seat in the vehicle so that clothes, soap, cosmetics, towels and other desired bathroom items can be taken directly from the seat by a person in the enclosure.

Preferably, the wall component or wall portion which hangs from the door support member hangs from straps or the like attached to the door support member so that the wall component is lower than the other walls or wall portions whereby a person in the enclosure can see outside the enclosure, or it may include a window opening.

The portable enclosures of the present disclosure may be more clearly understood and put into practical effect with reference to the following description and the accompanying drawings.

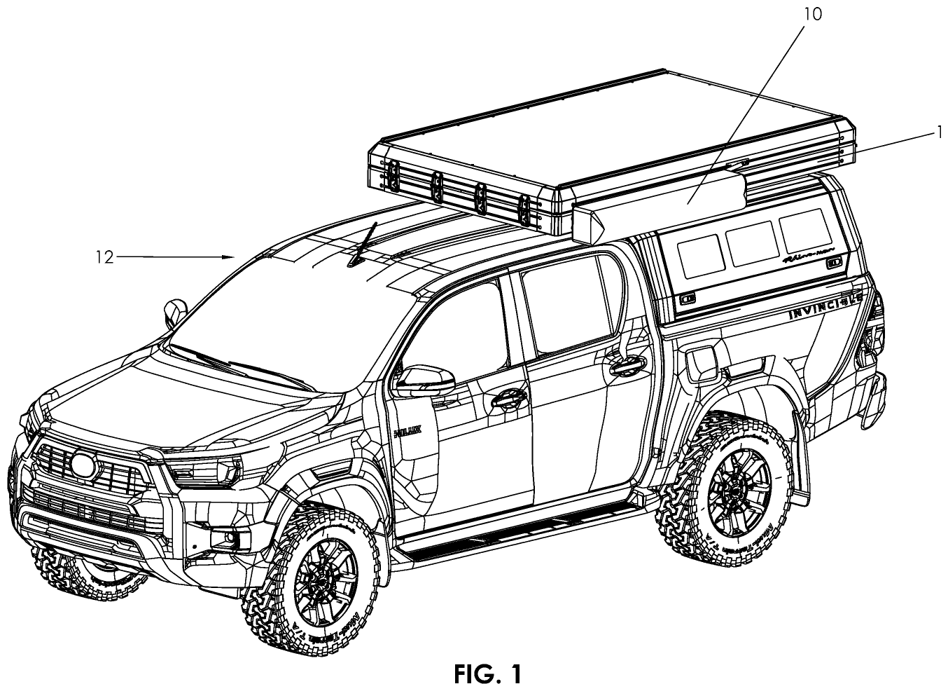

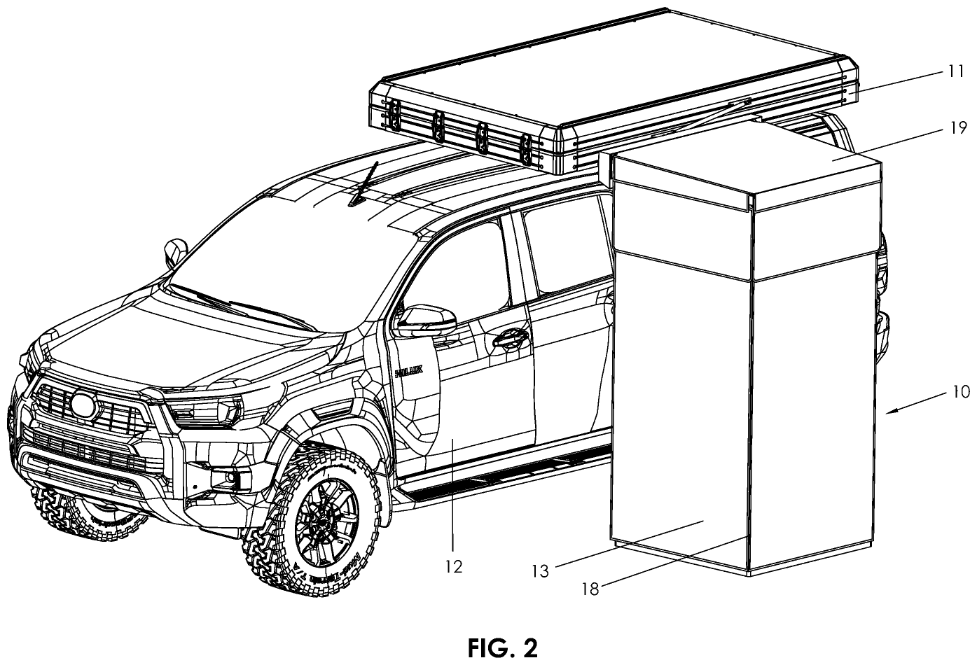

The portable shower enclosure 10 illustrated in FIG. 1 in its storage disposition, and its preferred travelling position, is mounted to the aluminum base 11 of a roof top tent which itself is mounted above the roof of a 4-wheel drive vehicle 12. It will be appreciated that when the roof top tent is raised to its erected disposition, the aluminum base remains in its generally horizontal disposition and the shower enclosure remains in its storage disposition until it is erected whereupon it will generally take the shape and position shown in FIG. 2. In other cases, the 4-wheel drive vehicle might have a roof rack fitted rather than a roof top tent, and in such cases, the shower enclosure could be mounted to a side or rear edge of the roof rack, or any other suitable mounting place where the enclosure may be put to use, preferably while remaining secured in its travelling position.

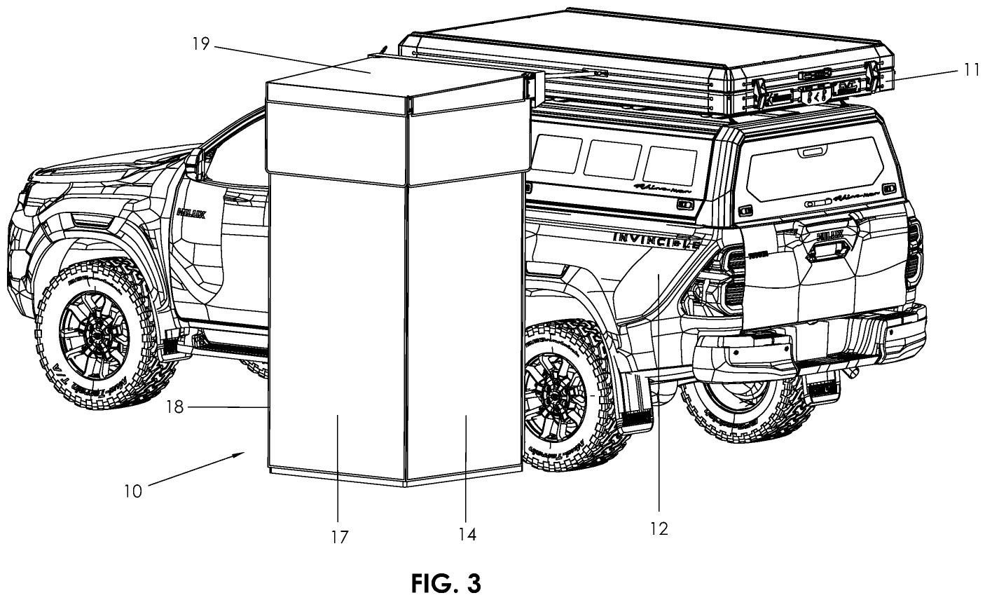

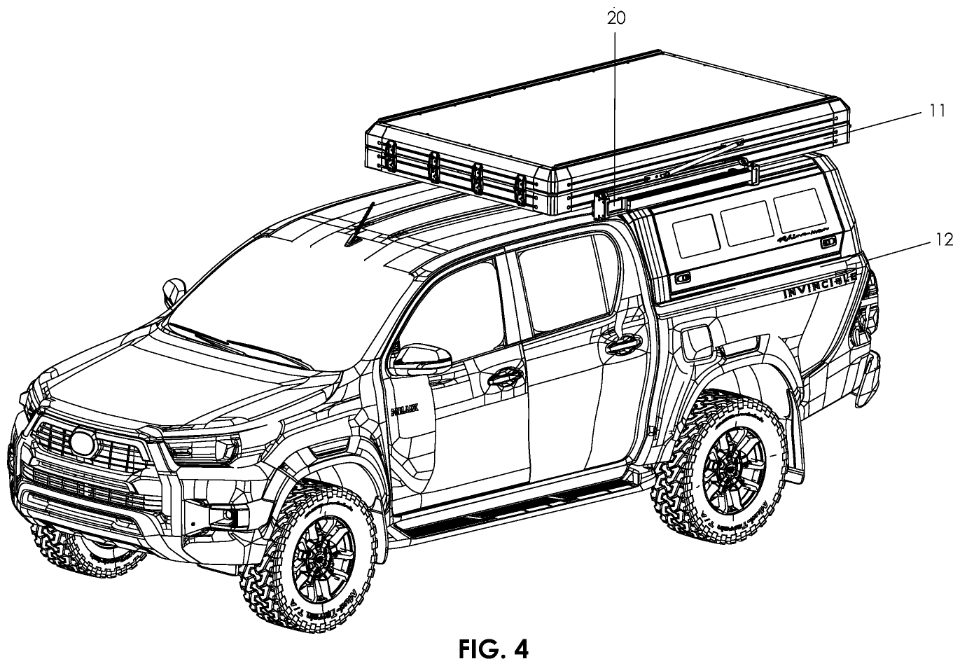

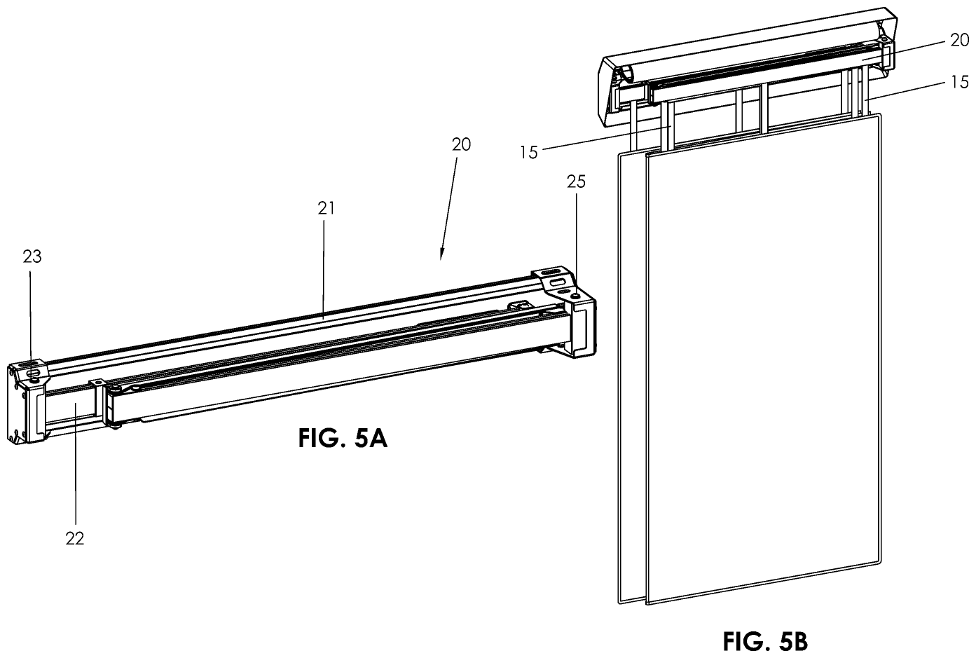

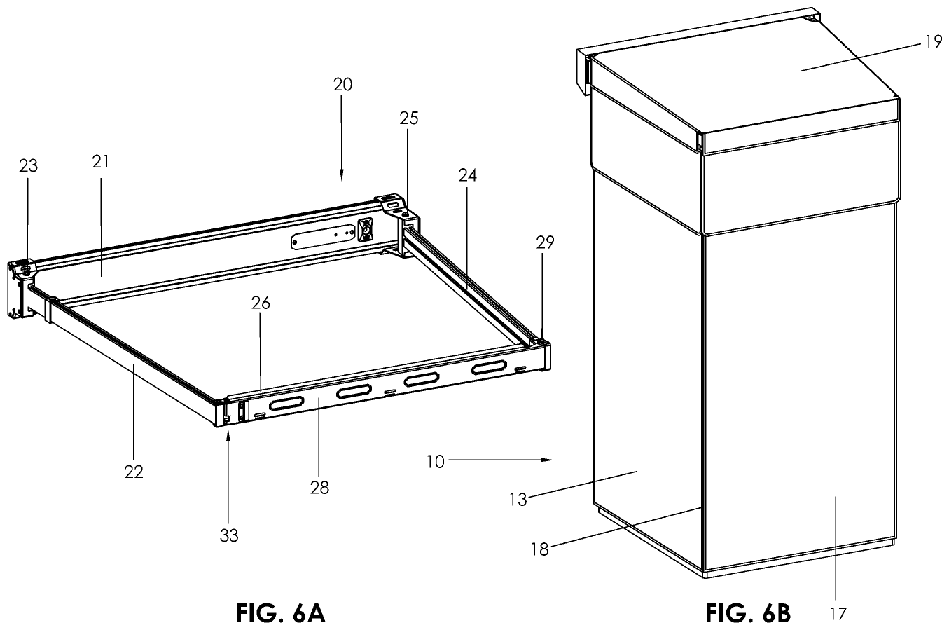

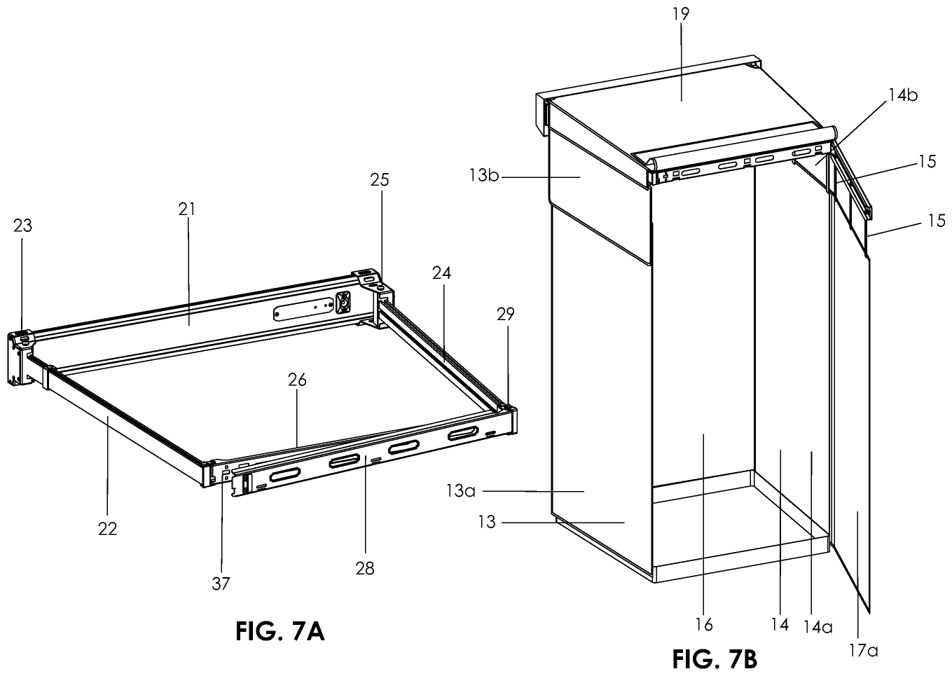

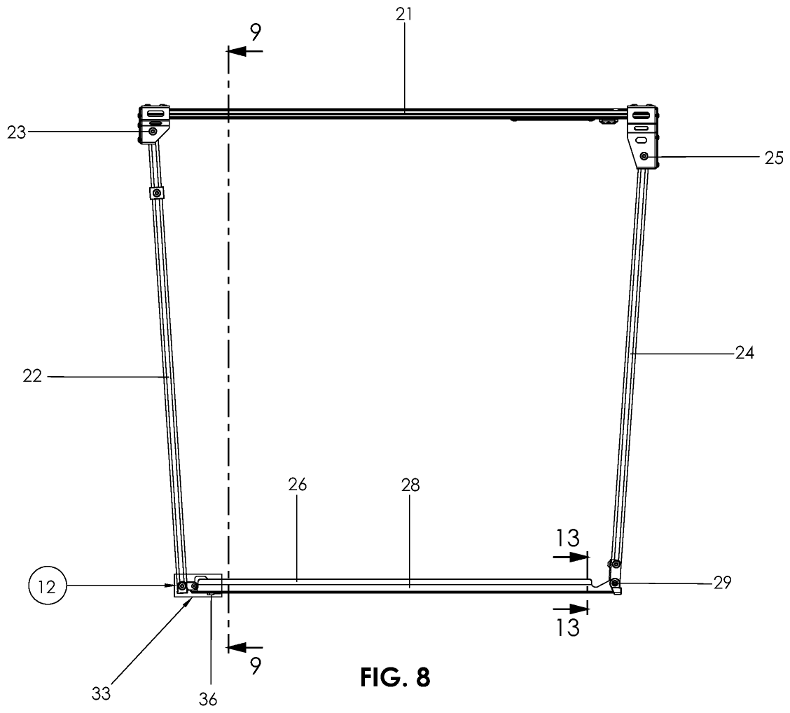

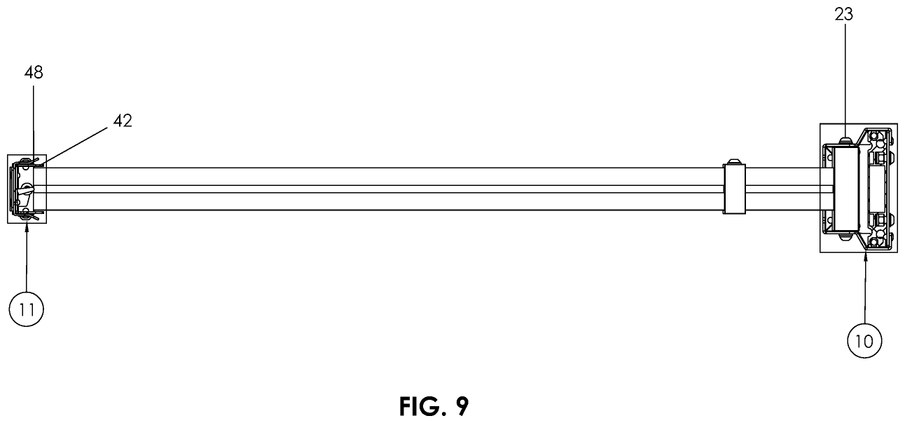

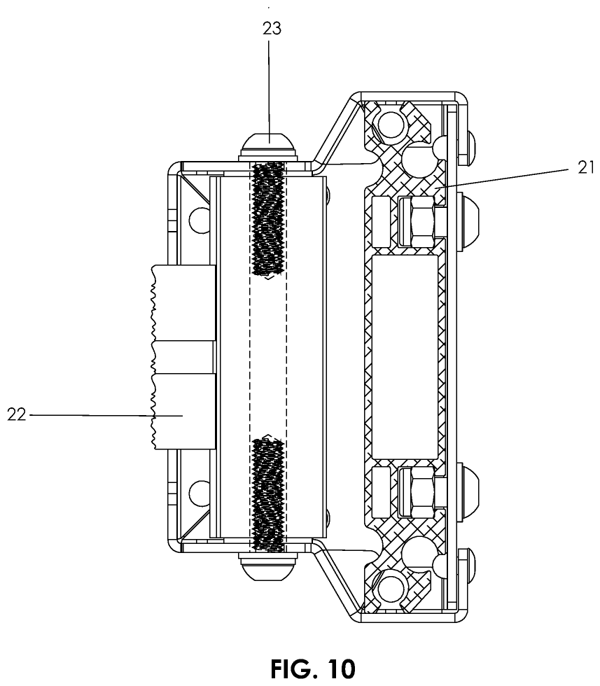

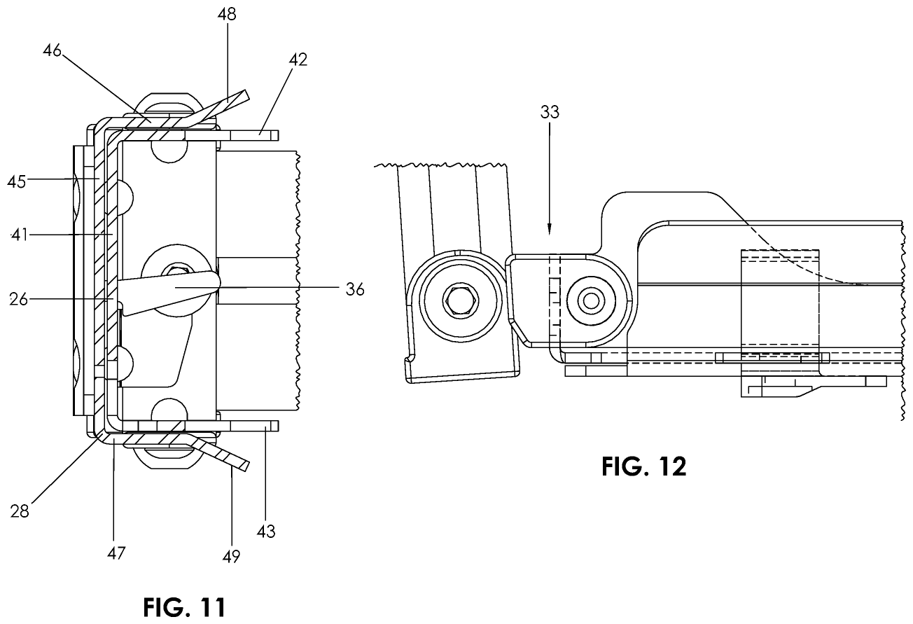

As can be seen in FIGS. 2 and 3 in which the shower enclosure is depicted in its erected disposition, the enclosure includes two opposing side walls 13 and 14, and a rear wall 16 (as can be seen more clearly in FIG. 7B) which are all made of canvas so that they can be rolled up for easy storage and unrolled to form the walls. Other flexible materials, for example lighter materials such as nylon cloth could be used if desired. The enclosure also includes a door panel 17 which opens and closes the space between the side walls 13 and 14.

In the embodiment illustrated in the drawings, each of the walls includes a large lower portion 13A, 14A, 16A and small separate upper portions 13B, 14B and 16B. The upper portions overhang the respective lower portions as can be seen more clearly in FIG. 7. Similarly, the door also includes a lower portion 17A which is also made of canvas but this embodiment does not include an upper portion in the door.

The lower portions in this embodiment of the invention, including the door portion 17A, are all adjacent portions of one sheet of canvas extending about the three sides and the door panel and are supported from a top frame 20 by spaced apart straps 15. The small upper portions of the three walls are separate pieces of canvas which can be rolled up individually to form “windows” which allow passage of air therethrough if desired. The upper portions of the three walls could be made of a synthetic gauze type cloth or similar if desired to allow some airflow at all times. In this particular embodiment of the invention the door panel does not have an upper wall portion which ensures that there is sufficient airflow through the enclosure to reduce the possibility of condensation in the enclosure.

The door panel meets the left side panel at the outer front left vertical corner 18 where a vertical zipper is provided to join the lower portion of the door panel to the side panel vertically when the door panel is closed. However, the small upper portions are individual panels which can be folded up or rolled up to allow air flow through the upper portion of the enclosure as mentioned and are not directly connected together. In the embodiment illustrated, the roof panel 19 is a separate independent sheet which is sized to overhang the upper wall portions, thereby assisting with ventilation and preventing ingress of rain.

It will be appreciated that although the bottom portions of the side walls and the door in the embodiment illustrated are all formed by one sheet of canvas, in other embodiments of the invention, the side walls and the rear wall are all separate individual sheets which are connected to each other at the vertical corners by zippers, hook and loop fasteners, straps or other suitable fasteners or connectors.

The collapsible top frame 20 includes a base member 21 which is adapted to be affixed to the base of the roof top tent 11 by screws, bolts, straps (or any other suitable securing means), a left side member 22, an opposing right side member 24, and a door head or front member 26 opposite the base member 21 and joining the front ends of the left and right side members.

The left side member 22 is pivotally connected to the base frame member 21 at its left hand end by pivot pin 23 for pivoting movement from a stowed position against the base frame member to an erected position extending therefrom at about 85 degrees.

Similarly, the right side member 24 is pivotally connected to the base frame member 21 at its other end by pivot pin 25 for pivoting movement from a stowed position beside the base frame member (but not against it) to an erected position in which it extends from the base frame member 21 also at about 85 degrees. As can be seen in FIGS. 7A and 7B, a door support member 28 is pivotally connected to the door head member (or front member) 26 at its right hand end for pivoting movement about pin 29 from a closed position against the front member 26 to an open position extending outwardly from the front member.

It will be appreciated that the top frame may be opened from the collapsed or storage disposition to an erected disposition by firstly pivoting right side member 24 outwardly away from the base member 21 with the front member 26 which is pivotally attached to the right side member at its outer end still against it and the door head member 28 against front member 26 and abutting it along its outside face, its upper face and its lower face so as to cover those three faces but not its inner face.

Then, the left hand member can be opened by pivotally moving left side member 22 to the erected position so as to extend outwardly from the base frame member whereupon the front member 26 can be pivoted about pivot pin 29 (which is adjacent the outer end of the right side member 24 and connected thereto by hinge bracket 30), from its position against the right side member to its erected position extending from the outer end of the right side member to the outer end of the left side member, such that it is spaced from base member 21 and parallel thereto.

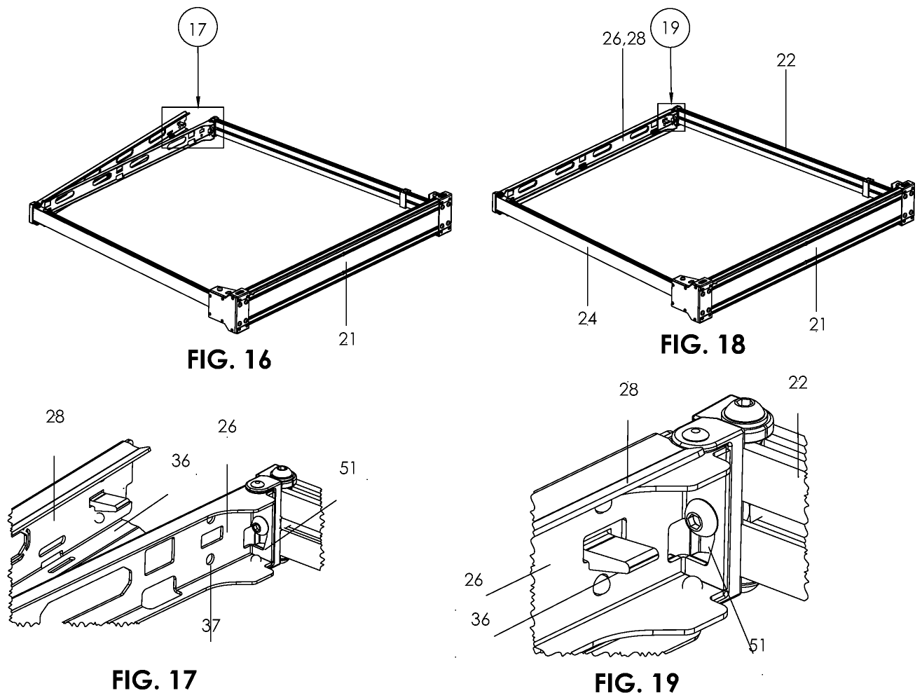

It will be seen that the front member 26 is secured to the left side member 22 by a latching mechanism 33 which can be seen in FIG. 33 at which stage the top frame is stabilized and the door support member is still secured to the front frame member by engagement of polyurethane latch 36 in opening 37 which can be more clearly seen in FIG. 17.

It will also be seen that the front member 26 substantially takes the form of a C-channel with a web portion 41 and parallel spaced apart flange portions 42 and 43 extending therefrom. The door support member 28 is substantially a complementary C-channel with a web portion 45 and similar spaced apart flange portions 46 and 47 and is arranged to substantially encapsulate the front member with the web portion 45 of the door support member 28 engaging the web portion 41 of the front member and the two flange portions 46 and 47 of the door support member engaging the corresponding flange members 42 and 43 of the front member respectively as can be more clearly seen in FIG. 13. It will also be seen that the flange portions of the door support member terminate in flared end portions 48 and 49 which assist with initial engagement of the door support member 28 and the front member 26.

Advantageously, the arrangement allows the front member 26 together with the door support member 28 to require very little additional width over just the front member when the door is in the closed position. That situation carries through to the collapsed disposition with the result that the depth of the collapsible frame when in the collapsed disposition is substantially minimized and consequently can be mounted to a roof rack or the base of a roof top tent for travel without extending too far sideways from the vehicle. However, it will be appreciated that the shower enclosure is also capable of being stored in the luggage compartment of the 4-wheel drive vehicle and erected at the desired destination by securing the top frame to a tree trunk, suitable branch or some other structure.

Further, when in the erected in-use disposition, the arrangement allows the door support member to be fully supported along its length which-minimizes the load on the pivot pin 29 when in the closed position.

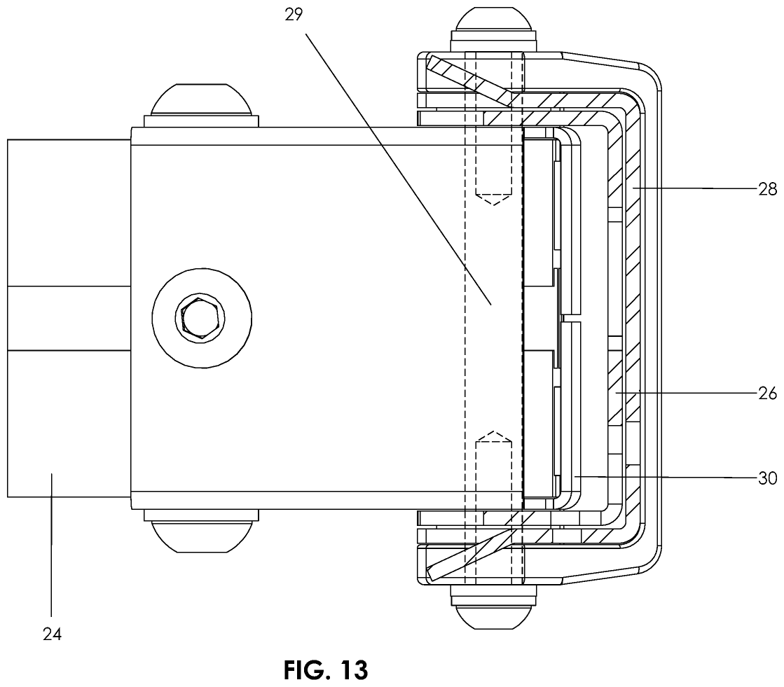

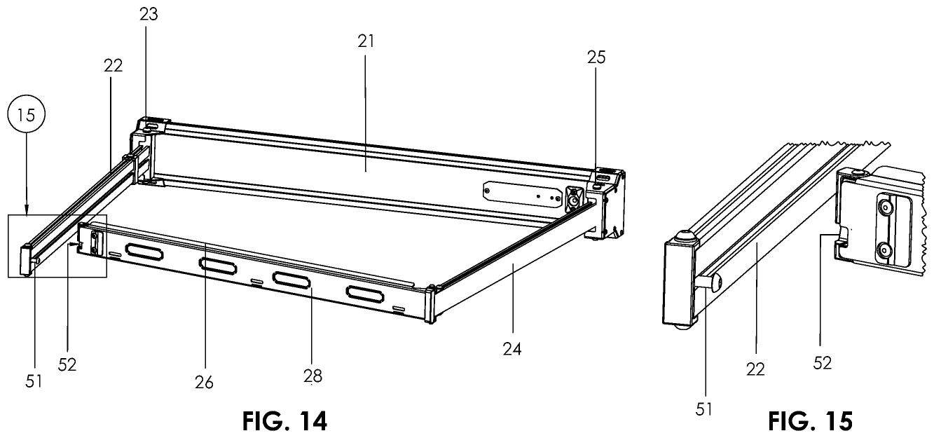

As can be seen in FIGS. 14 and 15, the front member 26 is releasably secured to the left side member by engagement of a pin 51 (extending from the left side member) in a recess 52 provided in the front member 26 thereby assisting in stabilizing and strengthening the top frame.

In use, the shower enclosure 10 is mounted to the base of the roof top tent or roof rack or any other suitable structure as the case may be as shown in the drawings. Upon arrival at the desired destination, the protective cover 15 is removed or suitably folded back to reveal the enclosure within whereupon the collapsible top frame is erected as previously described while at the same time allowing the canvas walls and door to unfold and hang from the top frame whereupon the shower enclosure is ready for use.

While the foregoing description has been given by way of illustrative example of the invention, it will be understood that the invention may be embodied in many other forms and all such forms are deemed to fall within the broad scope and ambit of the invention as hereinbefore described.

1-13. (canceled)

14. A portable enclosure, comprising:
a collapsible frame that is adapted to be mounted to a structure; and
a flexible wall that is operatively connected to the collapsible frame so that the flexible wall can depend therefrom to form a screen;
wherein the collapsible frame includes a door head member and a door support member, the door support member being adapted to move from a closed position adjacent to the door head member to an open position extending from the door head member and vice versa; and the flexible wall includes a portion or component that is operatively connected to the door support member so as to hang therefrom to form a door screen.

15. The portable enclosure of claim 14, wherein the collapsible frame is adapted to be mounted to a roof structure of a vehicle.

16. The portable enclosure of claim 14, wherein the collapsible frame is adapted to be mounted to a vehicle roof rack or a vehicle roof top tent.

17. The portable enclosure of claim 15, wherein the collapsible frame includes a base member adapted to be mounted to the roof structure of the vehicle, and the collapsible frame further includes one or more additional frame members arranged to fold towards the base member in sequence, so that the first additional frame member is placed against the base member, the second additional frame member is placed against the first additional frame member, and so on.

18. The portable enclosure of claim 17, wherein the one or more additional frame members include two spaced-apart side wall members arranged to fold and unfold towards and away from the base member, and the door head member and the door support member together are arranged to fold against one of the side wall members.

19. The portable enclosure of claim 18, wherein the door support member is arranged to fold about one end of the door head member.

20. The portable enclosure of claim 18, wherein the door support member and the door head member can be selectively opened and closed; and the door support member and the door head member include complementary latching mechanisms such that the door support member and the door screen can be latched when in a closed position.

21. The portable enclosure of claim 18, wherein the door support member is arranged to at least partly encapsulate the door head member.

22. The portable enclosure of claim 17, wherein the flexible wall includes a window portion disposed beneath the base member, and the window portion can be opened and closed.

23. The portable enclosure of claim 14, wherein the portion or component of the flexible wall that hangs from the door support member to form a door screen is adapted to hang from the door support member in such a way that the door screen is lower than one or more other walls or wall portions in order to provide ventilation.

24. The portable enclosure of claim 23, wherein the door screen hangs from the door support member by one or more straps.

25. The portable enclosure of claim 17, wherein the base member further comprises a hook or an opening to support a shower head thereon.

26. The portable enclosure of claim 17, wherein the flexible wall includes a portion hanging from the base member, and the flexible wall portion extends fully to a ground, so that water sprayed within the portable enclosure is prevented from impinging on the structure to which the portable enclosure is mounted.

27. A collapsible frame for a portable enclosure, where the collapsible frame is adapted to be mounted to a roof structure of a vehicle, the collapsible frame comprising:
a door head member; and
a door support member, wherein the door support member is adapted to move from a closed position adjacent to the door head member to an open position beyond the door head member and vice versa, the collapsible frame including an attachment mechanism for attaching a hanging flexible wall thereto so that the hanging flexible wall forms an enclosure.

28. A portable enclosure including:
a collapsible frame adapted to be mounted to a vehicle roof rack, a vehicle roof top tent, or other suitable structure, wherein the collapsible frame is configured for actuation between a storage disposition and an erected disposition, and a flexible wall operatively connected to the collapsible frame, wherein the flexible wall is adapted to be folded and/or rolled for storage in or adjacent the collapsible frame when in the storage disposition and to hang from the collapsible frame when in the erected disposition to form a screen or wall.

29. A portable enclosure, comprising:
a collapsible frame; and
a flexible wall that is operatively connected to the collapsible frame;
wherein the collapsible frame is adapted to be mounted to a vehicle roof rack, a vehicle roof top tent, or other suitable structure, whereby the flexible wall can depend therefrom to form a screen; the collapsible frame includes a door head member and a door support member, wherein the door support member is adapted to move from a closed position adjacent to the door head member to an open position beyond the door head member and vice versa.
